(19) United States
(12) Patent Application Publication
(10) Pub. No.: US 2013/0294694 A1
(43) Pub. Date: Nov. 7, 2013

(54) Zone Based Scanning and Optical Character Recognition for Metadata Acquisition

(71) Applicants: Jia Zhang, Irvine, CA (US); Silvy Wilson, Rancho Santa Margarita, CA (US); Michael Yeung, Mission Viejo, CA (US)

(72) Inventors: Jia Zhang, Irvine, CA (US); Silvy Wilson, Rancho Santa Margarita, CA (US); Michael Yeung, Mission Viejo, CA (US)

(73) Assignees: Toshiba Tec Kabushiki Kaisha, Shinagawa-ku (JP); Kabushiki Kaisha Toshiba, Minato-ku (JP)

(21) Appl. No.: 13/461,620

(22) Filed: May 1, 2012

(51) Int. Cl. G06K 9/18; G06K 9/20

(52) U.S. Cl. 382/182; 382/321

(57) ABSTRACT

There is disclosed a method and apparatus for zone based scanning and optical character recognition for metadata acquisition comprising receiving user input identifying a first zone and a second zone on a visible representation of an electronic document and associating the first zone with a first database category and the second zone with a second database category, the association made using a metadata map. The method further comprises scanning a physical document in order to obtain a digital representation of the physical document as an electronic document, performing optical character recognition on the first zone and the second zone on the electronic document to thereby obtain a first metadata element and a second metadata element, and storing the electronic document along with the first metadata element and the second metadata element in a database, the first and second metadata elements stored in the database as directed by the metadata map.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to zone based scanning and optical character recognition for metadata acquisition.

2. Description of the Related Art

A multifunction peripheral (MFP) is a type of document processing device which is an integrated device providing at least two document processing functions, such as print, copy, scan, and fax. In a document processing function, an input document (electronic or physical) is used to automatically produce a new output document (electronic or physical).

Documents may be physically or logically divided into pages. A physical document is paper or other physical media bearing information which is readable by the typical unaided human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as a document, unless the context requires some discussion of physical documents which will be referred to by that name specifically.

In printing, the MFP automatically produces a physical document from an electronic document. In copying, the MFP automatically produces a physical document from another physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

Visible elements of a physical document may be scanned and, if desired, recognized by optical character recognition software to thereby obtain a verbatim digital transcript of an otherwise physical document. It is desirable to have full text searchable versions of electronic documents in addition to electronic document images created by scanning a physical document. However, storing all of the text of a document is undesirable because it requires more storage space and additional database capacity, both for database storage and for database searching. In many cases, the searching need only identify a document which may, then, be reviewed by an individual for content.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a portion of a user interface showing a zone template selection tool.

FIG. 6 is a portion of a user interface showing a zone selection and database linking tool.

FIG. 7 is a portion of a user interface showing a file naming tool using a default file name.

FIG. 8 is a portion of a user interface showing a file naming tool using a file name based upon document content.

FIG. 9 is a flowchart for the operation of the system for zone based scanning and optical character recognition for metadata acquisition.

Throughout this description, elements appearing in figures are assigned three-digit reference designators, where the most significant digit is the figure number and the two least significant digits are specific to the element.

### DETAILED DESCRIPTION

Description of Apparatus

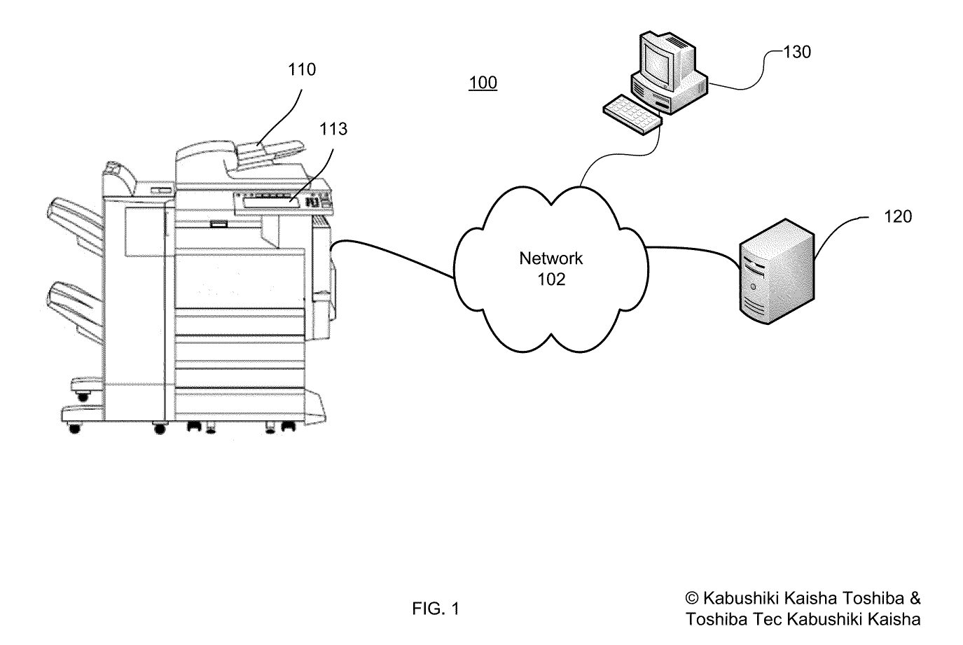

Referring now to FIG. 1 there is shown an MFP system 100. The illustrated system 100 includes an MFP 110, a server 120, and a client computer 130, all interconnected by a network 102. The system 100 may be implemented in a distributed computing environment and interconnected by the network 102.

The network 102 may be a local area network, a wide area network, a personal area network, the Internet, an intranet, or any combination of these. The network 102 may have physical layers and transport layers according to IEEE 802.11, Ethernet or other wireless or wire-based communication standards and protocols such as WiMax®, Bluetooth®, the public switched telephone network, a proprietary communications network, infrared, and optical.

The MFP 110 may be equipped to receive portable storage media such as USB drives. The MFP 110 includes a user interface 113 subsystem which communicates information to and receives selections from users. The user interface subsystem 113 has a user output device for displaying graphical elements, text data or images to a user and a user input device for receiving user inputs. The user interface subsystem 113 may include a touchscreen, LCD display, touch-panel, alpha-numeric keypad and/or an associated thin client through which a user may interact directly with the MFP 110.

The server 120 may be software operating on a server computer connected to the network 102. The server 120 may be, for example, a Microsoft® Sharepoint® server or a database server. The client computer 130 may be a PC, thin client or other device. The client computer 130 is representative of one or more end-user devices and may be considered separate from the system 100.

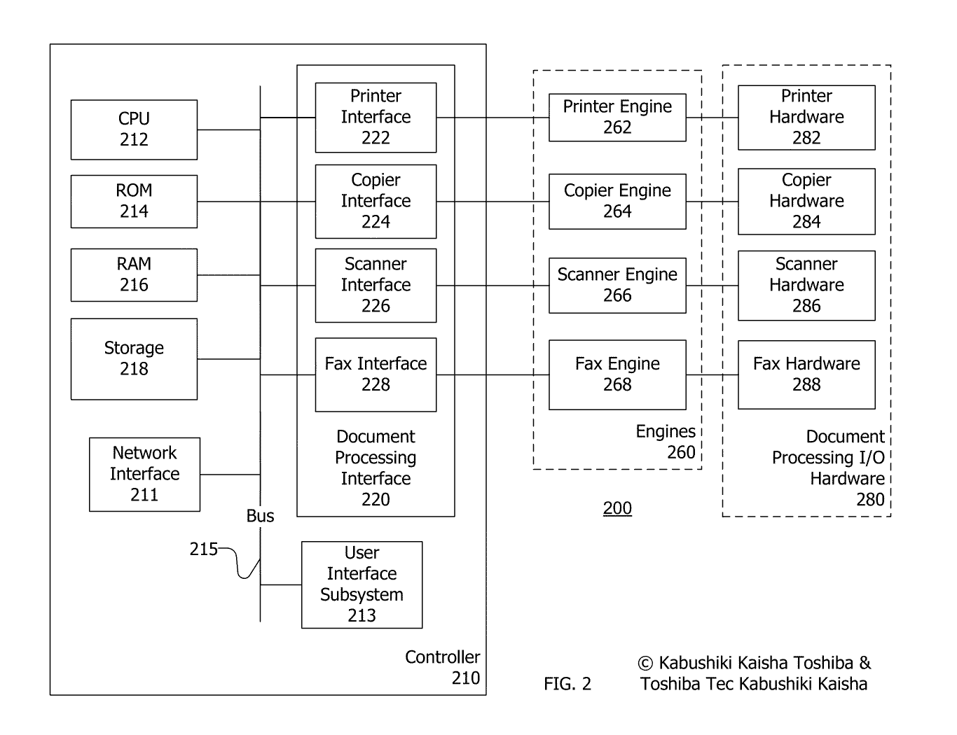

Turning now to FIG. 2 there is shown a block diagram of an MFP 200 which may be the MFP 110 (FIG. 1). The MFP 200 includes a controller 210, engines 260 and document processing I/O hardware 280. The controller 210 may include a CPU 212, a ROM 214, a RAM 216, a storage 218, a network interface 211, a bus 215, a user interface subsystem 213 and a document processing interface 220.

As shown in FIG. 2 there may be corresponding components within the document processing interface 220, the engines 260 and the document processing I/O hardware 280, and the components are respectively communicative with one another. For example, the printer interface 222 can be communicative with the printer engine 262, which can be communicative with the printer hardware 282. The document processing interface 220 may have a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, operating system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from, and provide output to, the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions.

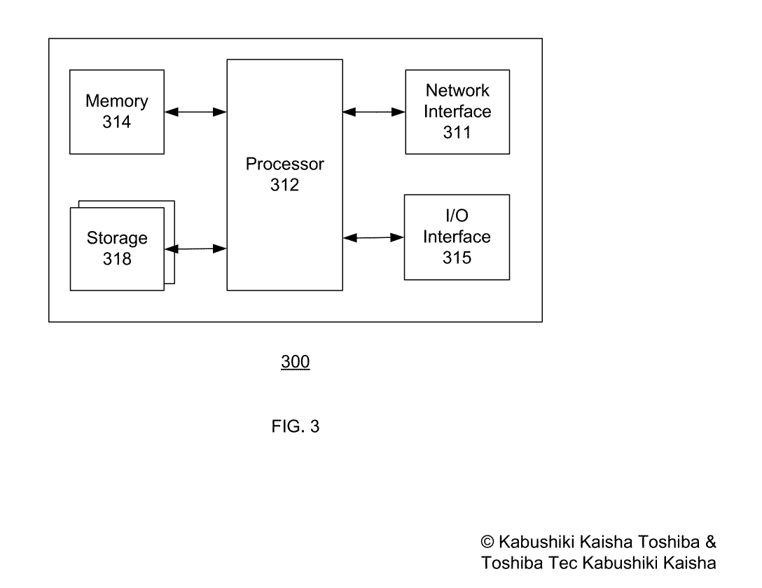

Turning now to FIG. 3 there is shown a computing device 300, which is representative of the server computers, client devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors, field programmable gate arrays (FPGAs), application specific integrated circuits (ASICs), programmable logic devices (PLDs) and programmable logic arrays (PLAs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

As used herein, the term storage medium corresponds to the storage 318 and does not include transitory media such as signals or waveforms.

The network interface 311 includes an interface to a network such as network 102 (FIG. 1).

The I/O interface 315 interfaces the processor 312 to peripherals (not shown) such as displays, keyboards and USB devices.

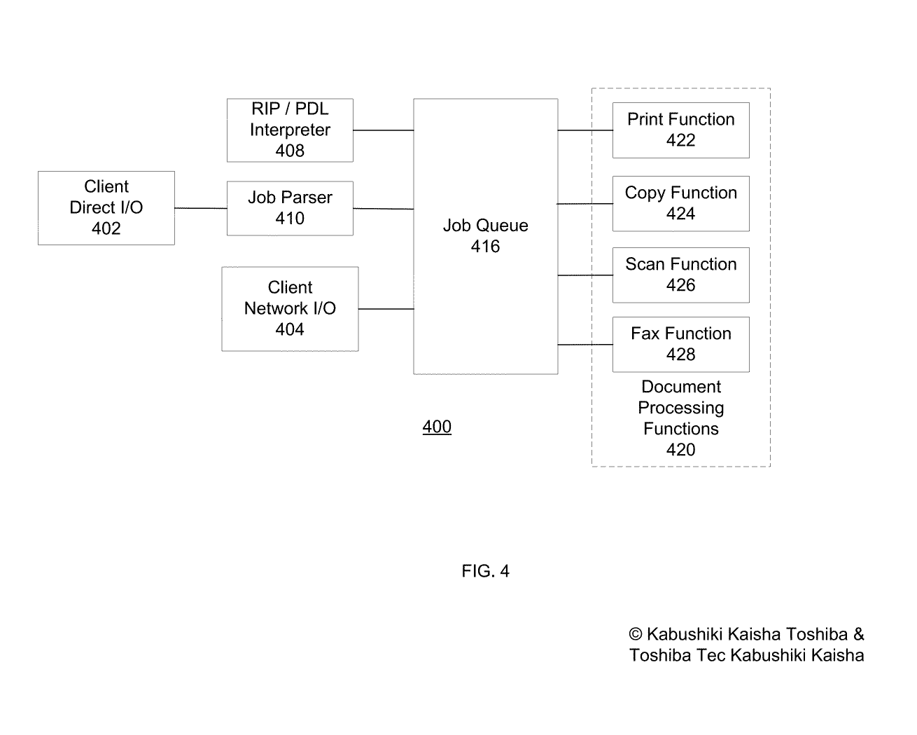

Turning now to FIG. 4 there is shown a block diagram of a software system 400 of an MFP which may operate on the controller 210 (FIG. 2). The system 400 includes client direct I/O 402, client network I/O 404, a RIP/PDL interpreter 408, a job parser 410, a job queue 416, and a series of document processing functions 420 including a print function 422, a copy function 424, a scan function 426 and a fax function 428.

The client direct I/O 402 and the client network I/O 404 provide input and output to the MFP controller. The client direct I/O 402 is for the user interface on the MFP (e.g., user interface subsystem 113), and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail TELNET or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the system 400.

The print function 422 enables the MFP to print documents and implements each of the various functions related to that process. These may include stapling, collating, hole punching, and similar functions. The copy function 424 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer or thin client. For example, the user interface for some or all document processing functions may be provided locally by the MFP's user interface subsystem, though the document processing function is executed by a computing device separate from but associated with the MFP.

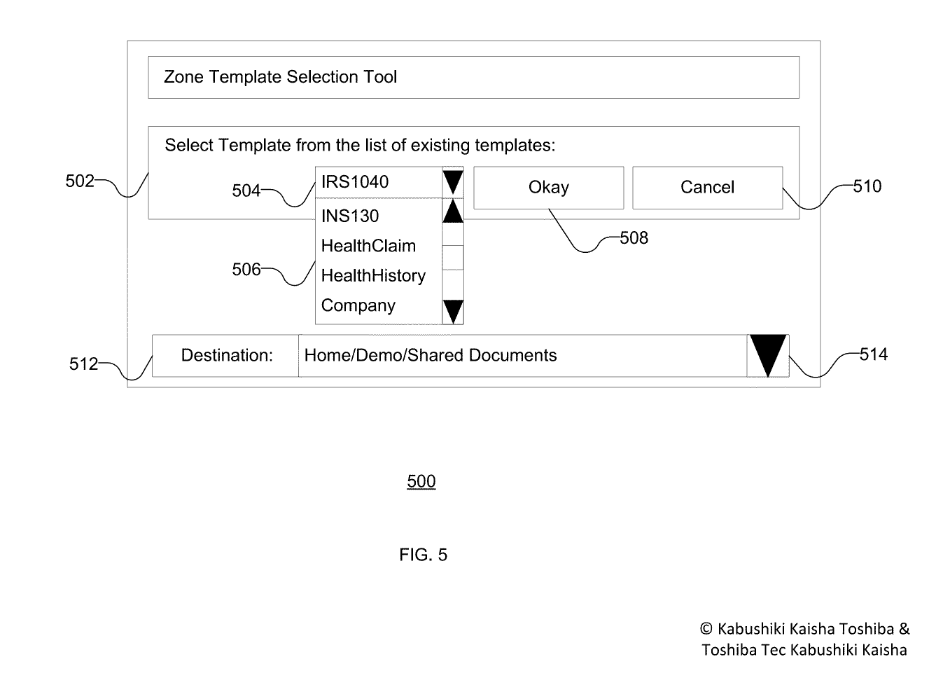

FIG. 5 is a portion of a user interface 500 showing a zone template selection tool. The user interface 500 includes a box that enables the selection of a template 502. The box may include a current selection 504 in a dropdown menu 506 in addition to an Okay button 508 and a Cancel button 510. The user interface 500 may also include a destination label 512 with a directory box 514 that may include a dropdown menu as well.

The user interface 500 may be generated as a part of the user interface 113 of the MFP 110 or, alternatively may be generated on a user interface of an associated thin client or personal computer.

The user can select a pre-existing or previously-created template from the dropdown menu 506. These templates include a metadata map that defines zones of an electronic document and metadata that appears in those zones. The metadata map is used to identify the zones and to direct them to appropriate fields (or categories) in databases that are to be used to store the metadata from those zones.

For example, the current selection 504 in FIG. 5 is “IRS 1040” representative of the Internal Revenue Service form 1040 used for most U.S. individual tax returns. The 1040 form includes an individual's name, address, birth date, social security number and other tax-related information. The IRS 1040 template may define zones, using coordinates relative, for example, to the top, left corner of an electronic document, that may be scanned and upon which optical character recognition (“OCR”) may be performed in order to obtain data from those zones. These zones may correspond to the information appearing on the associated form.

It may be inefficient, insecure or otherwise undesirable for a database to OCR an entire electronic document such as the IRS 1040 form for each taxpayer. However, obtaining a name, social security number, birth date and address may be sufficient to uniquely identify an individual in the database. Once identified, the actual document may be reviewed as-necessary. Accordingly, the IRS 1040 template may identify the zones of the document including those data elements. Alternative templates such as the INS130, the HealthClaim and HealthHistory templates may define different zones than that of the IRS 1040 template, each including different data. A corresponding metadata map for each of those templates may indicate the field or category in a database to which the metadata for each zone is to be stored.

An example of a template metadata map may be made in extensible markup language and may appear, for example for the HealthHistory template, in a format similar to the following:

<Form Name=‘HealthHistoryForm’>

<MetadataMap>

<MetadataField PageNumber=‘1’>

<Name>DocTitle</Name>
<ZoneArea>

<LeftX>985</LeftX>
<TopY>621</TopY>
<Width>716</Width>
<Height>81</Height>

</ZoneArea>

</MetadataField>
<MetadataField PageNumber=‘1’>
<Name>PatientName</Name>

<ZoneArea>

<LeftX>492</LeftX>
<TopY>406</TopY>
<Width>488</Width>
<Height>87</Height>

</ZoneArea>

</MetadataField>
<MetadataField PageNumber=‘1’>

<Name>ID</Name>
<ZoneArea>

<LeftX>2137</LeftX>
<TopY>396</TopY>
<Width>183</Width>
<Height>90</Height>

</ZoneArea>

</MetadataField>

</MetadataMap>

</Form>

The “<MetadataField PageNumber=‘1’>” indicating that the associated zone or zones are on the first page of the electronic document. The “<Name>” tag indicating a name for the metadata field. This metadata field may correspond to a database field or category under which the associated metadata is to be stored. The “<ZoneArea>” tag and its subsidiary tags setting forth the top, left corner and the pixel width and height therefrom that are to be scanned and upon which optical character recognition is to be performed. The above XML template metadata map is only an example. Other languages, formats, tags, organization and systems may be used in order to define a metadata map for mapping zones of OCR data to database fields or categories.

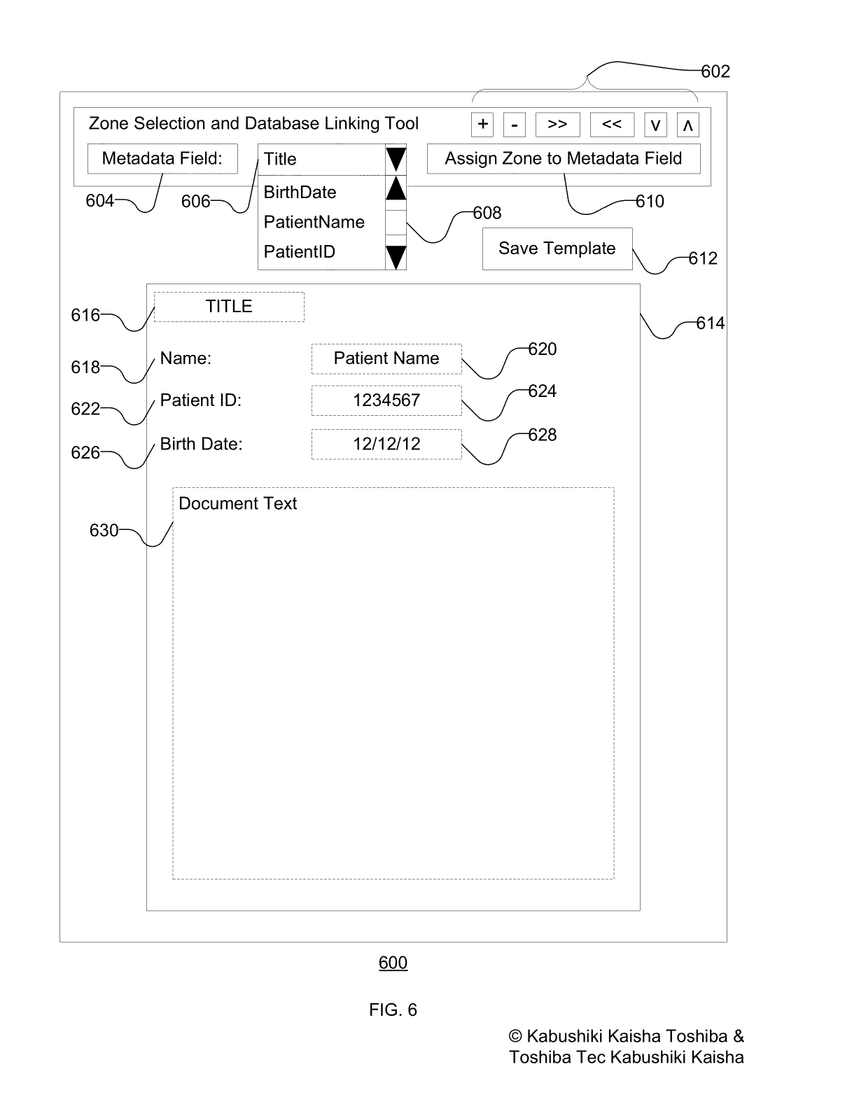

FIG. 6 is a portion of a user interface 600 showing a zone selection and database linking tool. This tool may be used to identify zones and to associate them with metadata fields. Once associated, a template may be created and saved An image of an electronic document 614 is shown on the user interface 600. The user may utilize several interactive buttons 602 to manipulate the electronic document 614 on the user interface 600. These buttons 602 may be used to zoom in, zoom out, move to the end or beginning of a multi-page electronic document 614 or to move one page forward or one page back in the multi-page electronic document 610. The buttons 602 are only examples, but navigation via interactive elements, such as the interactive buttons 602 may be provided as a part of the zone selection and database linking tool.

The metadata field label 604 may be situated next to a text box 606 into which a user may input a title for a metadata field. A dropdown menu 608 may also indicate previously-used or currently-used metadata fields for the current template. Once a user selects or inputs a metadata field, the user may identify a zone to associate with the metadata field. For example, the metadata title text box 606 lists “Title” as a metadata field. The title zone 616 is a portion of the electronic document 616 highlighted by the user that includes the “title.” This is an indication that documents of the type identified by this template include data in the highlighted area that the user wishes to associate with the metadata field “Title” in the identified title zone 616.

The user may use a mouse to click and drag a rectangular selection box around the title zone 616. A user may utilize multiple simultaneous touches on a user interface 600 to create a rectangular selection box around the title zone 616. A user may input a set of top and left coordinates in addition to pixel height and length for the title zone 616. A plurality of other input options may be utilized in order for a user to identify the location, placement and size of the title zone 616 associated with the metadata field labeled “Title.”

Once the user has input the title zone 616 in the metadata title text box 606, the user may select the Assign Zone to Metadata Field button 610 to associate the title zone 616 with the input or selected metadata field title in the metadata title text box 606. After the user has identified metadata fields that are desired, has given them titles and has associated a related zone, the user may elect to save the template using the Save Template button 612. This stores the template for later use wherein the template may be presented as an option, for example, in the dropdown menu 506 in FIG. 5. Selecting the Save Template button 612 may bring up a template saving dialogue in which a user can save a template for use by anyone or by a particular user or group of users. The template may be saved locally on the MFP currently being used or may be stored in a network or cloud drive for access by any user of a group of associated (either by user login, intranet or other authentication method) MPFs or users.

Additional zones with associated metadata fields may also be selected in a similar manner. The area of the electronic document 614 following the label “Name” 618 may be identified as metadata field “PatientName” and be associated with the patient name zone 620. Similarly, the area of the electronic document 614 following the label “Patient ID” 622 may be identified as metadata field “PatientID” and be associated with patient ID zone 624. The “BirthDate” 626 metadata field may be associated with birth date zone 628. Once all zones 616, 620, 624 and 628 are associated with respective metadata fields using the Assign Zone to Metadata Field button 610, the template may be saved using the Save Template button 612. The document text 630, as described above, may not be associated with a metadata field or associated zone because OCR will not be performed on the document text 630.

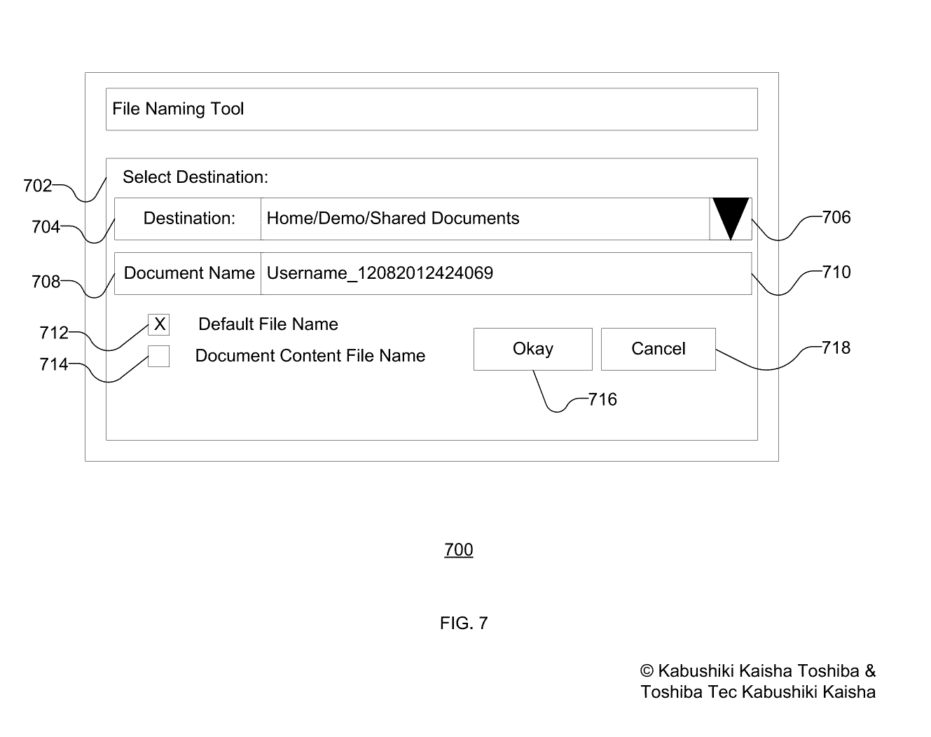

FIG. 7 is a portion of a user interface 700 showing a file naming tool using a default file name. This dialog or a similar dialog may appear after each document is scanned and data is obtained using OCR. Alternatively, this dialog may appear once, after a user selects the Save Template button 612 (FIG. 6) so that save settings may also be stored along with the template settings such that each time a document is scanned using the zone template, the associated data is stored in a location identified using this user interface 700.

The select destination box 702 includes a destination label 704 and a destination text box 706 which may include a dropdown menu. The destination box 702 enables the user to identify where files scanned using a zone template are subsequently stored. This destination may be local storage (e.g., on a local disk drive), network storage (e.g., a network share or file server), on the internet in a cloud or distributed file server, or in a database resident on an intranet or the internet. For example, the location may be a location in a Microsoft® Sharepoint® server. Authentication may be required from the user or from the MFP in order to access one or more of these destinations.

The select destination box 702 may include a document name label 708 and a document name text box 710 into which a user may input a document title or into which a default title may be automatically input. The user interface 700 indicates that the user has selected to utilize a default file name because the Default File Name checkbox 712 is selected while the Document Content File Name checkbox 714 is not. Selection of the Default File Name checkbox 712 causes the file naming tool to automatically name the file or files created as a result of the scanning using the zone based template. This automatic name may include a username and/or a date and/or a time of the scan. In addition, the automatic name may include a document number or “scan” number.

Once all selections and settings are made or input, the user may select the Okay button 716 to save those settings for the associated metadata template. Alternatively, the user may select the Cancel button 718 to exit the file naming tool and return to a prior screen.

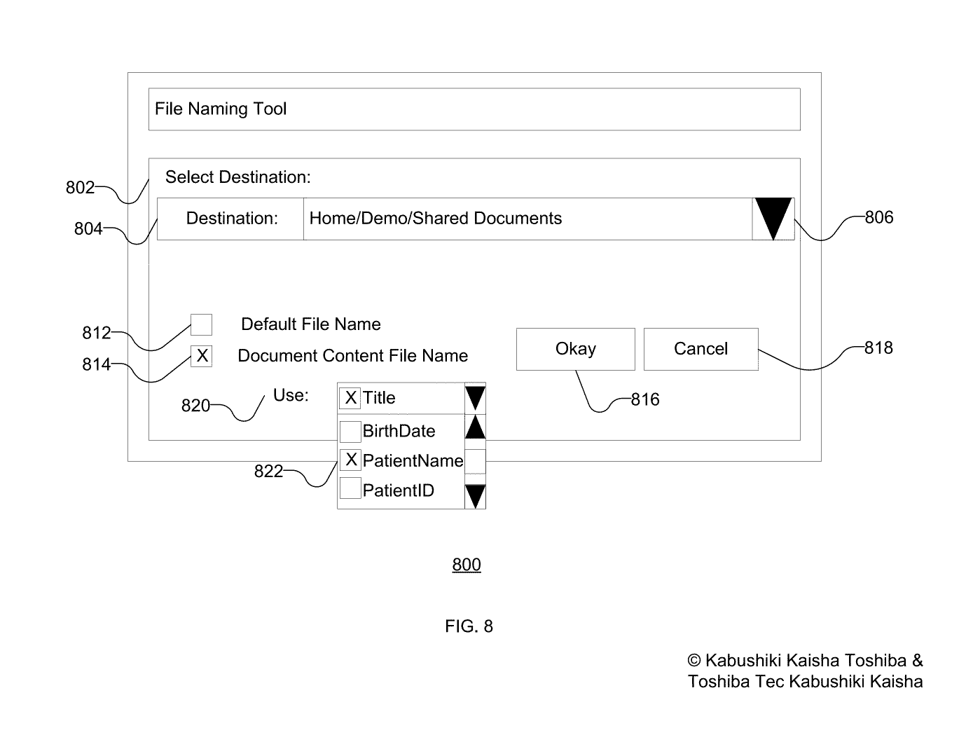

FIG. 8 is a portion of a user interface 800 showing a file naming tool using a file name based upon document content. This user interface 800 is similar to the user interface 700 (FIG. 7) except that the user has now selected the Document Content File Name checkbox 814. The select destination box 802, destination label 804, destination text box 806, Default File Name checkbox 812, Document Content File Name checkbox 814, Okay button 816 and Cancel button 818 operate in the same way and have the same functions as those described with reference to FIG. 7.

In FIG. 8, the Document Content File Name checkbox 814 has been selected. As a result, the use label 820 has appeared with the associated use dropdown menu 822. Using this menu 822, a user can select one or more metadata fields, such as those identified in FIG. 6, as portions of the document title. The document or documents created using the zone template tool can be named according to data obtained from the zones associated with each metadata field.

The resulting file name, for example, of the selected items in the use dropdown menu 822 will result in a file name including the title of the document and the patient name, for example, a file named “Patient_Name_Title” would result from the document 614 shown in FIG. 6. Additional metadata fields may be selected in the use dropdown menu 822 to customize the naming scheme. An associated metadata map stored along with the associated electronic document may be named in a manner similar to the electronic document such that the electronic document has a title of “Patient_Name_Title.tiff” and the associated metadata map has the title of “Patient_Name_Title.xml.”

The document and metadata map may be submitted to and subsumed by a database, file server, cloud storage, internet storage or other remote data storage for access by authorized users of the resulting data. For example, the data may be integrated into a Microsoft® Sharepoint® web-based access system for use and access by authorized Sharepoint® users. The metadata map may be created in such a way that enables integration with a database or other collaborative shared storage, such as a Sharepoint® site.

Description of Processes

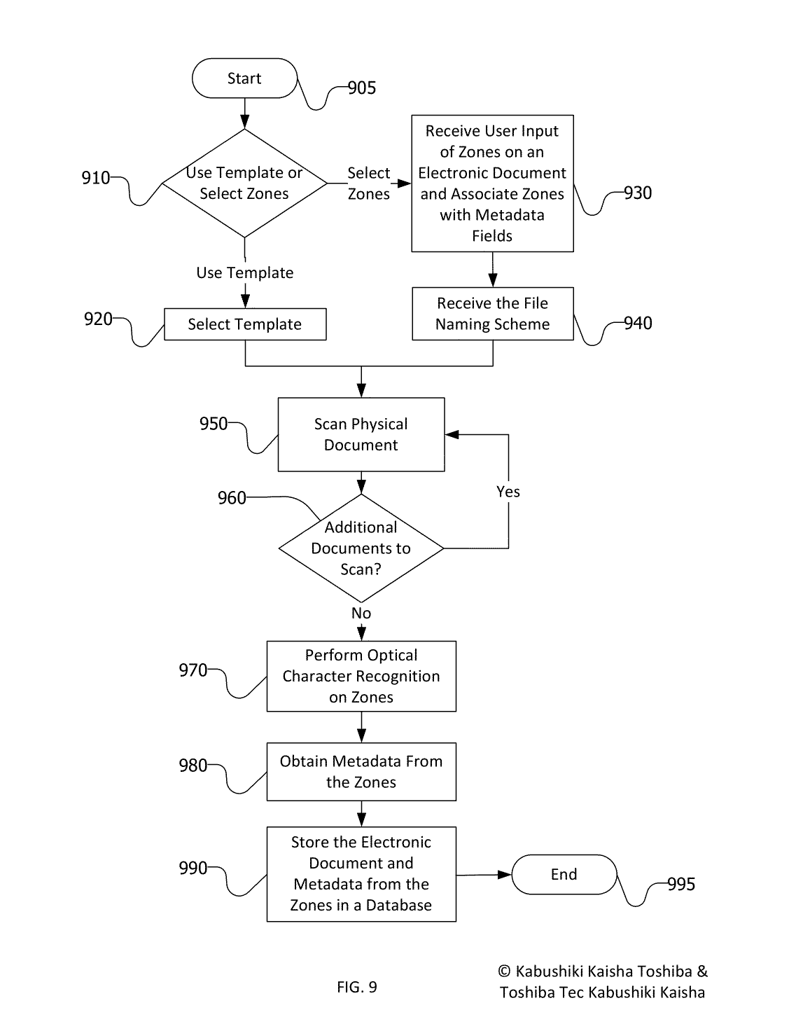

Turning now to FIG. 9, there is shown a flowchart for the operation of the system for zone based scanning and optical character recognition for metadata acquisition. A user may indicate, for example, via a user interface 113 of an MFP 110, that the user desires to use a metadata template or to select zones 910. This is an indication by the user of a desire to use or not use a preexisting template to perform the zone based scanning and optical character recognition for metadata acquisition. An indication that a user wishes to use a template results in the user needing to select the template to be used 920. An example of such a selection may be seen in FIG. 5. This selection is received via a user interface, such as user interface 113, and the selected template is identified to the controller for use in directing electronic documents created by subsequent document scanning.

An indication that a user wishes to select zones results in that user being prompted to input the zones, any titles and to associate the zones with metadata fields. This process may take place using an interface similar to that shown in FIG. 6. The system will then receive that user input of the zones and associated metadata fields 930. The zones and fields may be received, for example, via an MFP user interface such as user interface 113 (FIG. 1) or via a user interface on a related thin client, handheld computer or personal computer. The zones and associated metadata fields are received by a controller of the MFP in order to appropriately direct the scanning and OCR processes.

Next, the user may input and the system may receive the file naming scheme 940. User input of a file naming scheme is shown, for example, in FIGS. 7 and 8. The controller will operate to name the resultant electronic document and metadata file according to the naming scheme received from the user. This naming scheme may be input via the user interface 113 of the MFP 110, or may be input via a user interface of a thin client, handheld computer or personal computer associated with the MFP.

Once a template is selected at 920 or the user input of a naming scheme 930 for the zones and metadata fields, then the MFP is used to scan the physical document 950. At this step the scanner engine 266 and scanner hardware 286 are directed by the scanner interface 226 of the controller 210 (FIG. 2) to begin scanning the physical document. The scanner interface 226 is directed to scan the entire physical document.

If there are additional physical documents to scan 960, then those are also scanned 950. For example, a large number of physical documents of the same type may be scanned in rapid succession. The same template may be used for each of these physical documents scanned together such that a user need not designate or generate a template for each scanning operation. The template may be selected or generated once, then a plurality of documents of the type suitable for the template may be scanned together before the remainder of the method is undertaken for the documents. Alternatively, a template may be selected before each scanning process, then OCR and storage of that document may take place thereafter.

Optical character recognition is then performed on the zones of the, now, electronic document or documents 970. The optical character recognition is performed on the zones identified by the template at 920 or directly input by the user at 930. At this stage, optical character recognition is only performed on the zones identified by the template. The entire electronic document is maintained in an image file format. This optical character recognition may be undertaken by the controller 210 of the MFP 110 itself or may be undertaken by a server, such as server 120, associated with the MFP 110.

Once the optical character recognition is complete, the text within those zones is obtained and associated with the metadata field as directed by the template 980. Returning briefly to FIG. 6, the text “1234567” in the patient ID zone 624 is associated with the user-selected PatientID metadata field. An XML file, with a format similar to that shown above for the metadata map, or another type of data organization file may be created.

Finally, the electronic document is stored along with the metadata from the zones in a database 990. This storage will place the electronic document into a database along with the created XML (or other format) file (the “metadata file”), the metadata fields stored in the database according to the metadata map. The database may be hosted on a server, such as server 120 (FIG. 1) or hosted on the internet or in the cloud.

The electronic document and the metadata file may be combined into a meta-file in such a way that the meta-file will carry the metadata identified in the metadata fields in a form suitable for view by, for example, an operating system or software without viewing the image portion of the file. Attributes of the meta-file, such as patient name, patient ID, and birth date (FIG. 6), may be ascertainable by an operating system or software in a manner similar to viewing the file size, the file name, the date the file was last modified and other, similar attributes.

The electronic document and metadata file may be transmitted to, for example, a Microsoft® Sharepoint® server which generates web-accessible file shares. The Sharepoint® server can accept the electronic document and metadata file and store it in the destination identified during the template selection process shown, for example, in FIG. 5. The metadata fields may be incorporated into the Sharepoint® site as one of the attributes of the electronic documents. Sharepoint® enables users to sort and to search based upon the attributes of the documents shared thereon. These attributes may be augmented based upon the metadata fields associated with each electronic document or with a particular type of template chosen by a user.

In this way, the metadata fields may be incorporated into a database or file server, such as the Microsoft® Sharepoint® server. The method described herein results in an electronic document with associated metadata that are easy to categorize and search using relevant metadata fields defined by the zones, but do not require full-text OCR of every document.

The flow chart of FIG. 9 has both a start 905 and an end 995, but the process is cyclical in nature and may relate to one or more simultaneous instances of zone based scanning and optical character recognition for metadata acquisition taking place in parallel or in serial.

It is claimed:

1. A method for using zone based scanning and optical character recognition for metadata acquisition, comprising:
receiving user input identifying a first zone and a second zone on a visible representation of an electronic document;
associating the first zone with a first database category and the second zone with a second database category, the association made using a metadata map;
scanning a physical document in order to obtain a digital representation of the physical document as an electronic document;
performing optical character recognition on the first zone and the second zone on the electronic document to thereby obtain a first metadata element and a second metadata element; and
storing the electronic document along with the first metadata element and the second metadata element in a database, the first and second metadata elements stored in the database as directed by the metadata map.

2. The method of claim 1 wherein the user input is accepted via a user interface of a document processing device which performs the scanning.

3. The method of claim 1 wherein the storing includes naming the electronic document according to the first metadata element.

4. The method of claim 1 wherein the first zone and second zone are defined using a template uploaded by a user.

5. The method of claim 1 wherein the first database category and the second database category are obtained from the database and further comprising prompting a user to associate the first zone with the first database category and to associate the second zone with the second database category using the visible representation of the electronic document.

6. The method of claim 1 further comprising storing a first image data comprising a first electronic image of the first zone and a second image data comprising a second electronic image of the second zone along with the electronic document and the first metadata element and the second metadata element in the database.

7. A multifunction peripheral comprising:
a scanner for scanning a physical document in order to obtain a digital representation of the physical document as an electronic document;
a user interface for receiving user input identifying a first zone and a second zone on a visible representation of the electronic document; and
a controller for associating the first zone with a first database category and the second zone with a second database category, the association made using a metadata map, the controller further for performing optical character recognition on the first zone and the second zone on the electronic document to thereby obtain a first metadata element and a second metadata element, and the controller further for directing a server to store the electronic document along with the first metadata element and the second metadata element in a database, the first and second metadata elements stored in the database as directed by the metadata map.

8. The multifunction peripheral of claim 7 wherein the user input is accepted via a user interface of a document processing device which performs the scanning.

9. The multifunction peripheral of claim 7 wherein the directing a server to store includes naming the electronic document according to the first metadata element.

10. The multifunction peripheral of claim 7 wherein the first zone and second zone are defined using a template uploaded by a user.

11. The multifunction peripheral of claim 7 wherein the first database category and the second database category are obtained from the database and wherein the user interface is further for prompting a user to associate the first zone with the first database category and to associate the second zone with the second database category using the visible representation of the electronic document.

12. The multifunction peripheral of claim 7 wherein a first image data comprising a first electronic image of the first zone and a second image data comprising a second electronic image of the second zone are stored along with the electronic document and the first metadata element and the second metadata element in the database.

13. Apparatus comprising a storage medium storing a program having instructions which when executed by a processor will cause the processor to:
receive user input identifying a first zone and a second zone on a visible representation of an electronic document;
associate the first zone with a first database category and the second zone with a second database category, the association made using a metadata map;
scan a physical document in order to obtain a digital representation of the physical document as an electronic document;
perform optical character recognition on the first zone and the second zone on the electronic document to thereby obtain a first metadata element and a second metadata element; and
store the electronic document along with the first metadata element and the second metadata element in a database, the first and second metadata elements stored in the database as directed by the metadata map.

14. The apparatus of claim 13, wherein the user input is accepted via a user interface of a document processing device which performs the scanning.

15. The apparatus of claim 13, wherein the storing includes naming the electronic document according to the first metadata element.

16. The apparatus of claim 13, wherein the first zone and second zone are defined using a template uploaded by a user.

17. The apparatus of claim 13, wherein the first database category and the second database category are obtained from the database and wherein the instructions will further cause the processor to prompt a user to associate the first zone with the first database category and to associate the second zone with the second database category using the visible representation of the electronic document.

18. The apparatus of claim 13, wherein first image data comprising a first electronic image of the first zone and second image data comprising a second electronic image of the second zone are stored along with the electronic document and the first metadata element and the second metadata element in the database.

19. The apparatus of claim 13 further comprising:
a processor;
a memory; and
wherein the processor and memory comprise circuits and software for performing the instructions on the storage medium.
